(19) United States
(12) Patent Application Publication
(10) Pub. No.: US 2026/0287340 A1
(43) Pub. Date: Sep. 24, 2026

(54) UNSUPERVISED THICKNESS MEASUREMENT FOR NON-DESTRUCTIVE TESTING

(71) Applicant: Evident Canada, Inc., Québec (CA)

(72) Inventor: Alain Le Duff, Quebec (CA)

(21) Appl. No.: 19/168,704

(22) PCT Filed: Mar. 22, 2024
(86) PCT No.: PCT/CA2024/050346

§ 371 Date: Sep. 24, 2025

Related U.S. Application Data
(60) Provisional application No. 63/493,511, filed on Mar. 31, 2023.

(51) Int. Cl. G01B 17/02; G01N 17/00

(52) U.S. Cl. CPC G01B 17/02; G01N 17/00

(57) ABSTRACT

Various techniques are described for unsupervised thickness measurements and corrosion estimations in materials using an ultrasound inspection system utilizing non-destructive testing (NDT) methods. The system uses cepstral analysis to analyze a spectral power of an acoustic data signal acquired after an ultrasound probe assembly emits ultrasonic wave to identify distinct frequency contents associated with multiple echoes. Cepstral analysis allows the system to distinguish between different types of echoes, such as those from the front-wall and back-wall of the material and from any defects present within the material.

### CLAIM OF PRIORITY

This application claims the benefit of priority of U.S. Provisional Patent Application Ser. No. 63/493,511, titled “UNSUPERVISED THICKNESS MEASUREMENT” to Alain Le Duff, filed on Mar. 31, 2023, the entire contents of which being incorporated herein by reference.

### FIELD OF THE DISCLOSURE

This document pertains generally, but not by way of limitation, to techniques for non-destructive inspection and more particularly to techniques for performing thickness measurements acoustically.

### BACKGROUND

Non-destructive testing (NDT) may refer to use of one or more different techniques to inspect regions on or within an object, such as to ascertain whether flaws or defects exist, or to otherwise characterize the object being inspected. For example, a material thickness may be gauged such as using a magnetic or acoustic (e.g., ultrasonic) technique. Such gauging may be used for characterization of material thickness such as supporting inspection for manufacturing or corrosion monitoring, as illustrative examples. A thickness measurement instrument may be a stand-alone instrument comprising a transducer, display, and user input, or such inspection may be performed using an acoustic transducer assembly separate from a test instrument.

### SUMMARY OF THE DISCLOSURE

This disclosure is directed towards various techniques for unsupervised thickness measurements and corrosion estimations in materials using an ultrasound inspection system utilizing non-destructive testing (NDT) methods. The system uses cepstral analysis to analyze a spectral power of an acoustic data signal acquired after an ultrasound probe assembly emits ultrasonic wave to identify distinct frequency contents associated with multiple echoes. Cepstral analysis allows the system to distinguish between different types of echoes, such as those from the front-wall and back-wall of the material and from any defects present within the material. This is particularly important for identifying defects that may obscure the back-wall signal, such as pitting or delamination between the outer diameter (OD) and internal diameter (ID) of the sample.

In some aspects, this disclosure is directed to an ultrasound inspection system configured for determining a thickness of a material using a non-destructive testing (NDT) technique, the system comprising: a probe assembly configured to emit ultrasonic waves; and a processor configured for: acquiring an acoustic output signal of the material using the probe assembly; determining a cepstrum of the acoustic output signal; determining, based on the cepstrum of the acoustic output signal, a time of flight (TOF) of the ultrasonic waves within the material; determining the thickness of the material based on the determined TOF and a known speed of sound in the material; and outputting the determined thickness to a user interface.

In some aspects, this disclosure is directed to a method for determining a thickness of a material using a probe assembly configured to emit ultrasonic waves and a non-destructive testing (NDT) technique, the method comprising: acquiring an acoustic output signal of the material using the probe assembly; determining a cepstrum of the acoustic output signal; determining, based on the cepstrum of the acoustic output signal, a time of flight (TOF) of the ultrasonic waves within the material; determining the thickness of the material based on the determined TOF and a known speed of sound in the material; and outputting the determined thickness to a user interface.

In some aspects, this disclosure is directed to a machine-readable medium including instructions that, when executed by a machine, cause the machine to perform operations for: acquiring an acoustic output signal of a material using a probe assembly; determining a cepstrum of the acoustic output signal; determining, based on the cepstrum of the acoustic output signal, a time of flight (TOF) of ultrasonic waves within the material; determining a thickness of the material based on the determined TOF and a known speed of sound in the material; and outputting the determined thickness to a user interface.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example of an acoustic inspection system, such as may be used to perform one or more techniques described herein.

FIG. 2 depicts a relationship between the probe assembly and the material under test of FIG. 1.

FIGS. 3A-3C graphically depict the three component signals forming the acoustic output signal.

FIG. 4 graphically depicts the convolution of the three component signals, h₁(t), h₂(t), and e(t) of the acoustic output signal s(t).

FIGS. 5A-5C graphically depict the cepstral content of the probe response.

FIGS. 6A-6C graphically depict the cepstral content of the impulse response h1(t) of the water column.

FIGS. 7A-7C graphically depict the cepstral content of the impulse response h2(t) of the sample.

FIG. 8 is a flow diagram of an example of a method for determining a thickness of a material using a probe assembly configured to emit ultrasonic waves and a non-destructive testing (NDT) technique.

FIG. 9 graphically depicts a raw acoustic output signal and its envelope, showing the combination by convolution of all the components of the acoustic output signal.

FIGS. 10A-10C graphically depict the logarithm of the spectral power (logarithm spectrum) of the acoustic output signal.

FIG. 11 graphically depicts a cepstrum of the acoustic output signal.

FIGS. 12A and 12B graphically depict liftered cepstrums.

FIG. 13 illustrates a method 1300 for determining a thickness of a material using a probe assembly configured to emit ultrasonic waves and a non-destructive testing (NDT) technique in accordance with one embodiment.

FIG. 14 is a block diagram illustrating an example of a machine upon which one or more examples may be implemented.

### DETAILED DESCRIPTION

Acoustic techniques may be used to perform non-destructive testing (sometimes referred to generally as non-destructive evaluation) of structures by coupling acoustic energy onto or within such structures and detecting scattered or reflected energy corresponding to features on or within such structures under test.

The hallmark of ultrasonic phased array non-destructive testing is its capacity to focus and steer an acoustic beam at a desired position in an inspected object or part. The phased array focusing approach uses delays, applied on both the transmission and reception elements of the phased array probe, to synchronize the time of flights of short, pulsed waveforms at the position of interest. At the focal zone in the specimen, the width of the generated acoustic beam narrows, and the corresponding detection resolution increases.

Conventional phased array uses the physical superposition of elementary acoustic waves in transmission to produce an acoustic beam aimed at a specific focused depth in the inspected piece. The set of transmitter elements forms an aperture from which a coherent acoustic pulse emerges. The action of conventional phased array transmission is referred to as beamforming. In an S-scan, for instance, beamforming acquisition occurs for each user-specified angle. These angles may be zero degrees for thickness estimation.

In one approach, a plurality of acoustic transducers may be used to perform such acoustic inspection. Such a plurality of transducers may be referred to as an “array,” but such an array need not be planar or linear in arrangement or orientation and need not have a constant pitch between respective transducer elements.

Processing of received acoustic echo signals to form images may involve various techniques. In one acoustic acquisition approach, respective received acoustic echo signals may be “delayed and summed” to provide focusing within a specific locus on or within the structure under test.

In another approach, an acoustic acquisition technique called a “total focusing method” (TFM) may be used, such as involving a full-matrix capture (FMC) acquisition scheme where focus may be achieved across a broad spatial region on or within a structure under test. TFM also uses a delay-and-sum algorithm. Several TFM propagation modes are available, where the TFM propagation modes represent the path of ultrasound waves from the transmitter to an image pixel in a TFM zone and back to the receiver (including reflections).

Acoustic techniques may be used to measure the thickness of a material under test. The present inventor has recognized the desirability of performing acoustic thickness measurements in an unsupervised manner. The phrase “unsupervised” refers to the aspect of the present subject matter where a user is not required to manually enter certain inspection parameters, such as those related to time-gating. Such an “unsupervised” approach may also provide a numerical inspection result (e.g., a time of flight or thickness measurement). For example, because a user is not required to perform extraction of numerical measurement values, the present subject matter reduces or precludes users from being confounded by impulse response artifacts or other effects that are subject to misinterpretation.

This disclosure is directed towards various techniques for unsupervised thickness measurements and corrosion estimations in materials using an ultrasound inspection system utilizing non-destructive testing (NDT) methods. The system uses cepstral analysis to analyze a spectral power of an acoustic data signal acquired after an ultrasound probe assembly emits ultrasonic wave to identify distinct frequency contents associated with multiple echoes. Cepstral analysis allows the system to distinguish between different types of echoes, such as those from the front-wall and back-wall of the material and from any defects present within the material. This is particularly important for identifying defects that may obscure the back-wall signal, such as pitting or delamination between the outer diameter (OD) and internal diameter (ID) of the sample.

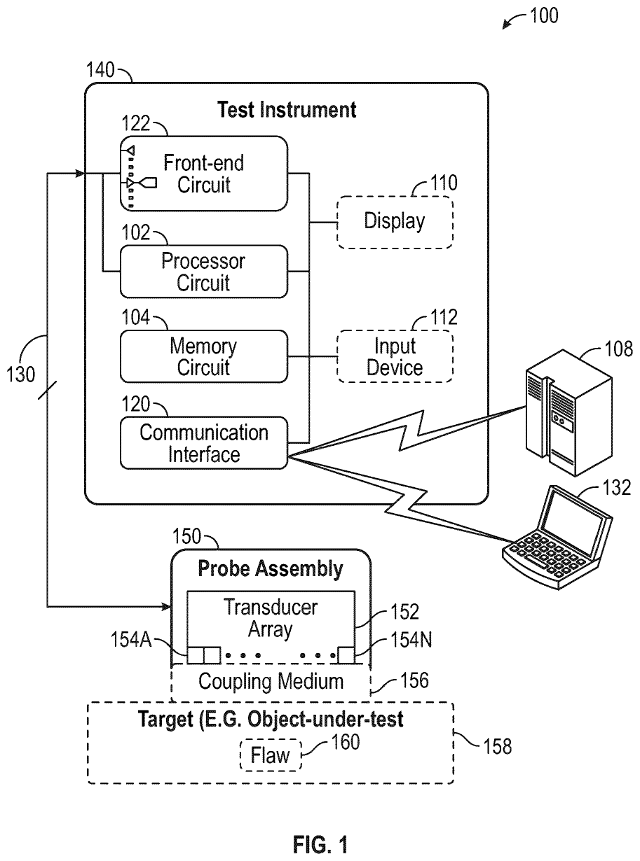

FIG. 1 illustrates generally an example of an acoustic inspection system 100, such as may be used to perform one or more techniques described herein. The acoustic inspection system 100 of FIG. 1 is an example of an acoustic imaging modality, such as an acoustic phased array system, that may implement various techniques of this disclosure.

The inspection system 100 may include a test instrument 140, such as a hand-held or portable assembly. The test instrument 140 may be electrically coupled to a probe assembly, such as using a multi-conductor interconnect 130. The probe assembly 150 may include one or more electroacoustic transducers, such as a transducer array 152 including respective transducers 154A through 154N, configured for emitting ultrasonic waves. The transducers array may follow a linear or curved contour or may include an array of elements extending in two axes, such as providing a matrix of transducer elements. The elements need not be square in footprint or arranged along a straight-line axis. Element size and pitch may be varied according to the inspection application.

A modular probe assembly 150 configuration may be used, such as to allow a test instrument 140 to be used with various probe assemblies 150. In a non-limiting example, the transducer array 152 may include piezoelectric transducers, such as may be acoustically coupled to a target 158 (e.g., an object or material under test) through a coupling medium 156, e.g., a liquid like water or gel. In other examples, capacitive micromachined ultrasonic transducer (CMUT) arrays may be used. In yet other examples, an Electro Magnetic Acoustic Transducer (EMAT) may be used. The coupling medium may include a fluid or gel or a solid membrane (e.g., an elastomer or other polymer material), or a combination of fluid, gel, or solid structures. For example, an acoustic transducer assembly may include a transducer array coupled to a wedge structure comprising a rigid thermoset polymer having known acoustic propagation characteristics (for example, Rexolite® available from C-Lec Plastics Inc.), and water may be injected between the wedge and the structure under test as a coupling medium 156 during testing.

The test instrument 140 may include digital and analog circuitry, such as a front-end circuit 122 including one or more transmit signal chains, receive signal chains, or switching circuitry (e.g., transmit/receive switching circuitry). The transmit signal chain may include amplifier and filter circuitry, such as to provide transmit pulses for delivery through an interconnect 130 to a probe assembly 150 for insonification of the target 158, such as to image or otherwise detect a flaw 160 on or within the target 158 structure by receiving scattered or reflected acoustic energy elicited in response to the insonification.

Although FIG. 1 shows a single probe assembly 150 and a single transducer array 152, other configurations may be used, such as multiple probe assemblies connected to a single test instrument 140, or multiple transducer arrays 152 used with a single or multiple probe assemblies 150 for tandem inspection. Similarly, a test protocol may be performed using coordination between multiple test instruments 140, such as in response to an overall test scheme established from a master test instrument 140, or established by another remote system such as a computing facility 108 or general purpose computing device such as a laptop 132, tablet, smart-phone, desktop computer, or the like. The test scheme may be established according to a published standard or regulatory requirement and may be performed upon initial fabrication or on a recurring basis for ongoing surveillance, as illustrative examples.

The receive signal chain of the front-end circuit 122 may include one or more filters or amplifier circuits, along with an analog-to-digital conversion facility, such as to digitize echo signals received using the probe assembly 150. Digitization may be performed coherently, such as to provide multiple channels of digitized data aligned or referenced to each other in time or phase. The front-end circuit 122 may be coupled to and controlled by one or more processor circuits, such as a processor circuit 102 (also referred to as “processor”) included as a portion of the test instrument 140. The processor circuit 102 may be coupled to a memory circuit, such as to execute instructions that cause the test instrument 140 to perform one or more of acoustic transmission, acoustic acquisition, processing, or storage of data relating to an acoustic inspection, or to otherwise perform techniques as shown and described herein. The test instrument 140 may be communicatively coupled to other portions of the system 100, such as using a wired or wireless communication interface 120.

For example, the performance of one or more techniques as shown and described herein may be accomplished on-board the test instrument 140 or using other processing or storage facilities such as using a computing facility 108 or a general-purpose computing device such as a laptop 132, tablet, smart-phone, desktop computer, or the like. For example, processing tasks that would be undesirably slow if performed on-board the test instrument 140 or beyond the capabilities of the test instrument 140 may be performed remotely (e.g., on a separate system), such as in response to a request from the test instrument 140. Similarly, storage of data or intermediate data such as A-line matrices of time-series data may be accomplished using remote facilities communicatively coupled to the test instrument 140. The test instrument may include a display 110, such as for presentation of configuration information or results, and an input device 112 such as including one or more of a keyboard, trackball, function keys or soft keys, mouse interface, touch-screen, stylus, or the like, for receiving operator commands, configuration information, or responses to queries.

As described in more detail below and using the techniques of this disclosure, the acoustic inspection system 100 may acquire an acoustic output signal of the target 158 (the material under test) using the probe assembly, where the acoustic output signal includes multiple echoes resulting from an interaction of the emitted ultrasonic waves within the material. The processor circuit 102 determines a cepstrum of the acoustic output signal. The cepstrum is a mathematical transformation of a signal's spectrum. It is useful for identifying periodicity, pitch estimation, and detecting harmonic structures in signals. The processor circuit 102 then determines, based on the cepstrum of the acoustic output signal, a time of flight (TOF) of the ultrasonic waves within the material. The processor circuit 102 then determines the thickness of the material based on the determined TOF and a known speed of sound in the material, and outputs the determined thickness to a user interface, such as the display 110.

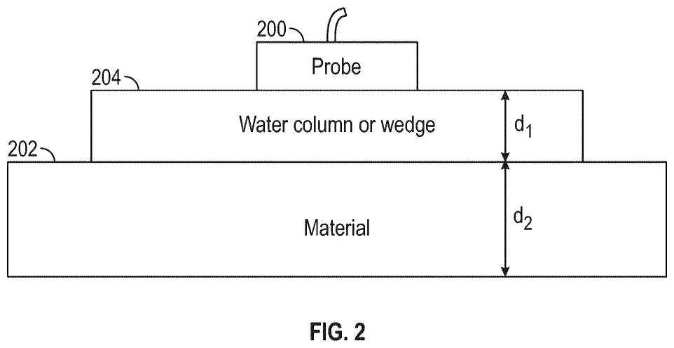

FIG. 2 depicts a relationship between the probe assembly and the material under test of FIG. 1. The probe assembly 200, e.g., the probe assembly 150 of FIG. 1, is coupled with a material 202, e.g., the target 158 of FIG. 1, via a coupling medium and/or wedge 204, e.g., the coupling medium 156 of FIG. 1.

The coupling medium and/or wedge 204 has a thickness of d1 and the material 202 has a thickness of d2, where d1 represents the front-wall position and d2 represents the back-wall position. In the context of ultrasound inspection and non-destructive testing (NDT), the terms front-wall and back-wall refer to the two primary interfaces of the material being inspected where ultrasonic waves are reflected.

The front-wall is the first boundary of the material that the ultrasonic waves encounter after traveling through the coupling medium and/or wedge 204 from the transducer. When the ultrasonic waves hit the front-wall, some of the energy is reflected back towards the transducer, and some of it is transmitted into the material. The front-wall echo is the reflection from this interface and is typically the first strong echo received by the transducer in a thickness measurement setup.

The back-wall is the boundary of the material opposite the front-wall. It is the interface where the ultrasonic waves are reflected back after traveling through the entire thickness of the material. The back-wall echo is the reflection from this interface and is used to determine the thickness of the material. The time interval between the front-wall and back-wall echoes, known as the time of flight (TOF), is directly related to the thickness of the material, given the known speed of sound in the material.

In summary, the front-wall is the initial boundary where the ultrasonic waves enter the material, and the back-wall is the boundary where the waves are reflected after passing through the material. The echoes from these walls are important in assessing the thickness and integrity of the material in ultrasonic NDT.

In a thickness measurement context by Phased-Array Ultrasound Technology (PAUT), the useful information is mainly concentrated in the time domain. Useful information may be carried by the signal magnitudes but may often be hidden by the experimental conditions (such as a fading effect, lack of coupling medium, etc.) or be dependent on the user (such as contact force variation). In such a context, it is recommended to exploit temporal methods, which allow access to the time position of echoes in the raw data, such as A-scan.

The height of the coupling medium and/or wedge 204 is such that the front-wall and back-wall echoes do not interfere. In other words, the acoustic path in the coupling medium and/or wedge 204 is longer than in the thickness of the material 202 to be inspected. In addition, if a defect (e.g., pitting, delamination) is located between the outer surface and the inner surface of the material 202 to be inspected, which are referred to as the outer diameter (OD) and internal diameter (ID) of a pipe, the techniques of this disclosure will hide the back-wall signal. The techniques of this disclosure are not limited for use with pipes.

In some examples, the corrosion mapping is performed using a linear scan at 0° in a pulse-echo mode using a phased array probe. The probe piezo-composite elements are driven by a negative and short electrical pulse. The acoustic output signal, which includes multiple echoes resulting from an interaction of the emitted ultrasonic waves with the material, is a combination of three component signals, h₁(t), h₂(t), and e(t), which represent respectively the successive echoes in the coupling medium and/or wedge 204, the successive echoes in the material, and the probe response to the input signal.

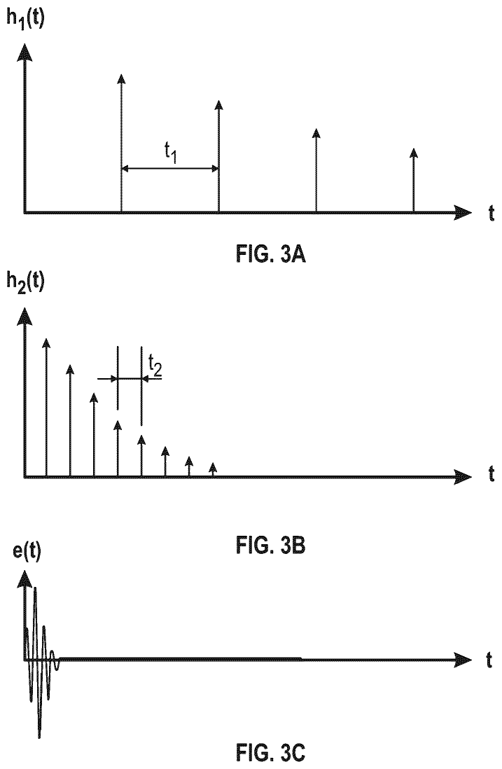

FIGS. 3A-3C graphically depict the three component signals forming the acoustic output signal. The x-axes represent time and the y-axes represent reflectivity. FIG. 3A depicts h₁(t), which is an impulse response of the coupling medium and/or wedge 204 of FIG. 2 to the input signal, and is defined by Equation 1:

$${h}_{1} ( t ) = exp ( - {α}_{1} t ) \cdot {\sum }_{- ∞}^{+ ∞} δ ( t - {kt}_{1} ) \qquad ( 1 )$$

where α₁ represents the effective attenuation, or damping factors, δ the Dirac distribution, and t₁ the time spacing between two successive impulses as illustrated in FIG. 3A. The time t₁ is given by Equation 2:

$$t\_ 1 = \frac{c\_ 1 \times d\_ 1}{2} \qquad ( 2 )$$

where d_1 and c_1 are, respectively, the height of the coupling medium and/or wedge 204 and the sound wave velocity in the coupling medium and/or wedge 204.

FIG. 3B depicts h₂(t), which is an impulse response of the material under test to the input signal, and is defined by Equation 3:

$${h}_{2} ( t ) = exp ( - {α}_{2} t ) \cdot {\sum }_{- ∞}^{+ ∞} δ ( t - {kt}_{2} ) \qquad ( 3 )$$

where α₂ represents the effective attenuation, or damping factors, δ the Dirac distribution, and t₂ the time spacing between two successive impulses as illustrated in FIG. 3B. The time t₂ is given by Equation 4:

$$t\_ 2 = \frac{c\_ 2 \times d\_ 2}{2} \qquad ( 4 )$$

where d_2 and c_2 are, respectively, the thickness of the material 202 and the sound wave velocity in the material 202.

FIG. 3C depicts e(t), which is a probe response to the input signal, and is defined by Equation 5:

$$e ( t ) = A ( t ) \cdot cos ( 2 π {F}_{c} t + {ϕ}_{0} ) \qquad ( 5 )$$

where A(t) represents the time-varying amplitude, also called envelope since e(t) complies with the narrow-band signal criteria, F_{C} is the central frequency of the probe in Hertz, and φ₀ the initial phase in radians.

These three signals, h₁(t), h₂(t), and e(t), all combine by convolution to form the acoustic output signal s(t) given by Equation 6:

$$s ( t ) = {h}_{1} ( t ) * {h}_{2} ( t ) * e ( t ) \qquad ( 6 )$$

where * denotes the convolution product.

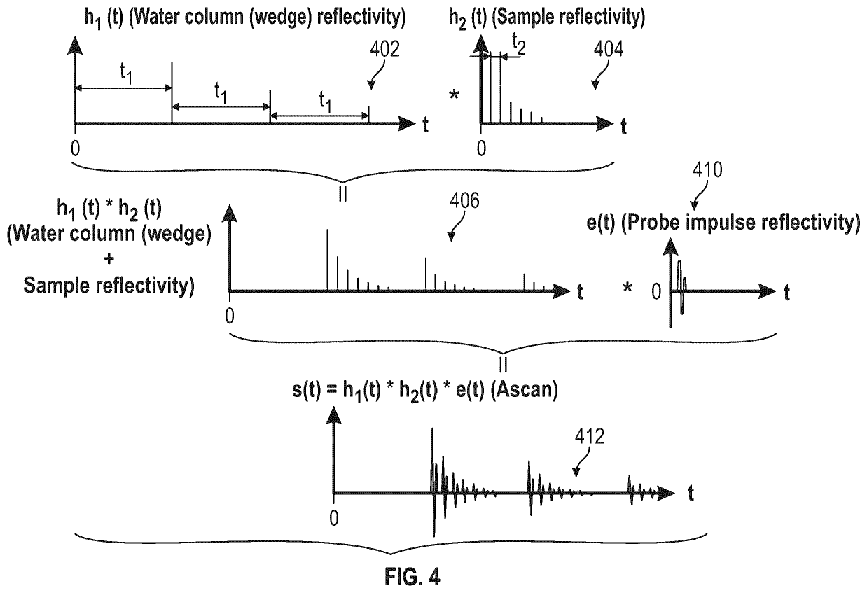

FIG. 4 graphically depicts the convolution of the three component signals, h₁(t), h₂(t), and e(t) of the acoustic output signal s(t). FIG. 4 depicts the convolution of h₁(t) at 402 with h₂(t) at 404, to generate the result depicted at 406. The time t₁ in 402 represents the time between the echoes in h₁(t), where h₁(t) is the impulse response of a water column or other coupling medium, or the wedge, to the input signal. The time t₂ in 404 represents the time between the echoes in h₂(t), where h₂(t) is the impulse response of the material under test to the input signal.

The convolution of h₁(t) at 402 with h₂(t) at 404 is shown at 406. The signal e(t) is shown at 410, where e(t) is a probe response to the input signal. The convolution of h₁(t)*h₂(t), shown at 406, is convolved with e(t), to produce the acoustic output signal s(t)=h₁(t)*h₂(t)*e(t), which is shown at 412.

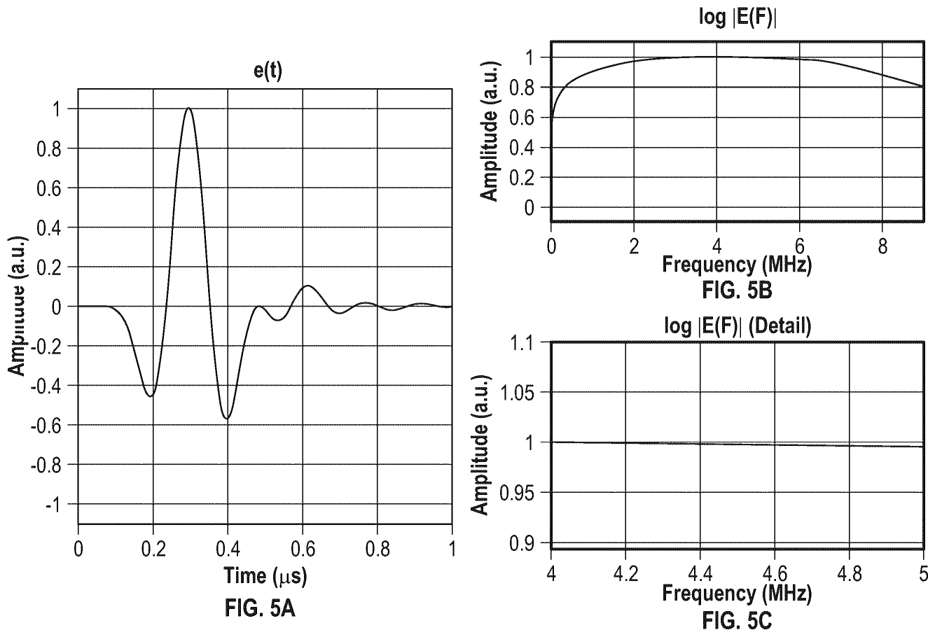

The signals h₁(t), h₂(t), and e(t) have distinct frequency contents. Indeed, the logarithm of the spectral power of signals containing multiple echoes, which is the case for h₁(t) and h₂(t), shows an additive periodic component. Consequently, the Inverse Fourier transform (IFT) of the logarithm of the spectral power shows a peak at the echo delay. This last function, called cepstrum, may be used to separate the respective components of the output signal. FIGS. 5A-5C show examples of the impulse response of the probe, its logarithm spectral power and a detail of its logarithm spectral power.

FIGS. 5A-5C graphically depict the cepstral content of the probe response. FIG. 5A depicts at 502 the probe impulse response e(t), where the x-axis is time in microseconds and the y-axis is amplitude in arbitrary units (a.u.). FIG. 5B depicts at 504 the log spectral power of the probe impulse response e(t) of FIG. 5A (log|E(F)|), where the x-axis is frequency in megahertz (MHz) and the y-axis is amplitude in arbitrary units (a.u.). FIG. 5C depicts the log spectral power of the probe of FIG. 5B in more detail at 506, where the x-axis is frequency in megahertz (MHz) and the y-axis is amplitude in arbitrary units (a.u.)

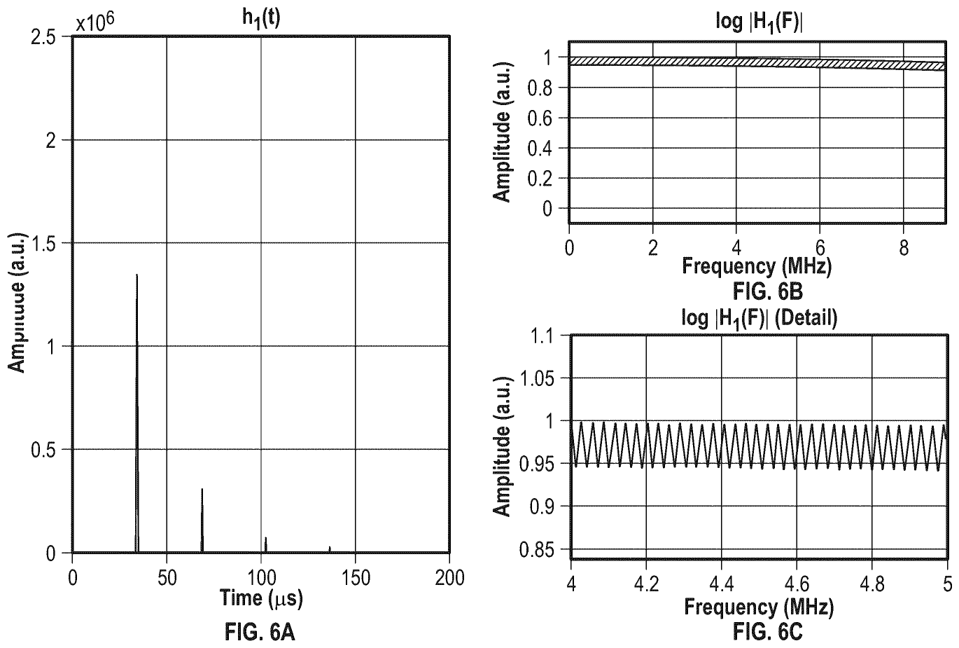

FIGS. 6A-6C graphically depict the cepstral content of the impulse response h1(t) of the water column. The signal may represent the impulse response h₁(t) of the coupling medium (e.g., the water column) or the wedge. FIG. 6A depicts at 602 the impulse response h₁(t), where the x-axis is time in microseconds and the y-axis is amplitude in arbitrary units (a.u.)

FIG. 6B depicts at 604 the log spectral power of the impulse response h₁(t) of FIG. 6A (log|H₁(F)|), where the x-axis is frequency in megahertz (MHz) and the y-axis is amplitude in arbitrary units (a.u.) FIG. 6C depicts the log spectral power of the impulse response FIG. 6B in more detail at 606, where the x-axis is frequency in megahertz (MHz) and the y-axis is amplitude in arbitrary units (a.u.)

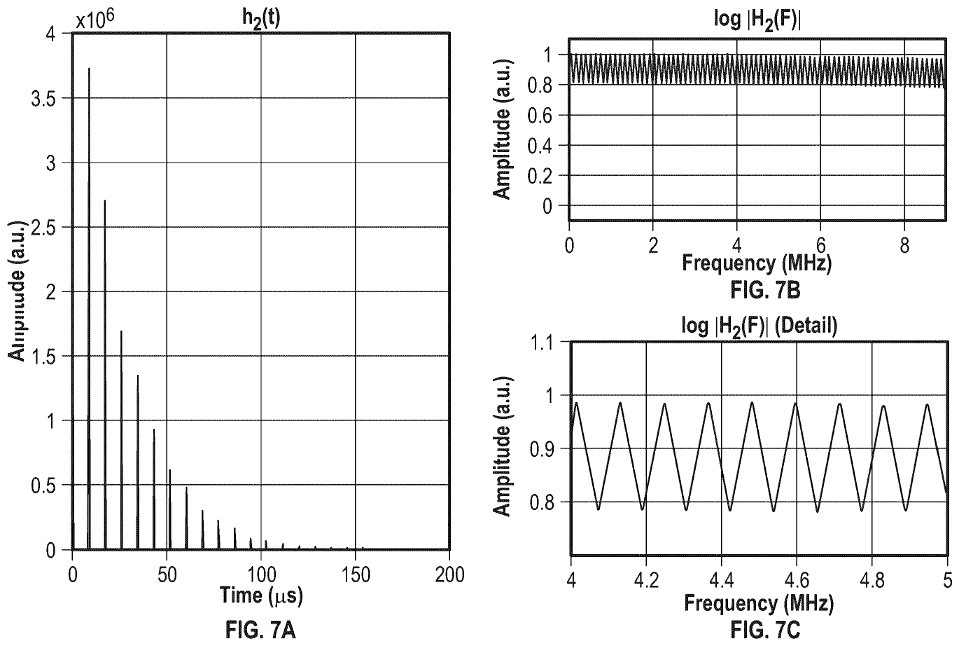

FIGS. 7A-7C graphically depict the cepstral content of the impulse response h2(t) of the sample. The signal may represent the impulse response h₂(t) of the material under test. FIG. 7A depicts at 702 the impulse response h₂(t), where the x-axis is time in microseconds and the y-axis is amplitude in arbitrary units (a.u.)

FIG. 7B depicts at 704 the log spectral power of the impulse response h₂(t) of FIG. 7A (log|H₂(F)|), where the x-axis is frequency in megahertz (MHz) and the y-axis is amplitude in arbitrary units (a.u.). FIG. 7C depicts the log spectral power of the impulse response of FIG. 7B in more detail at 706, where the x-axis is frequency in megahertz (MHz) and the y-axis is amplitude in arbitrary units (a.u.)

The system described by Equation 6 is nonlinear and is called a homomorphic system. However, this kind of system satisfies a generalization of the superposition principle. Notably, the three components h₁(t), h₂(t), and e(t) and their respective responses, are combined by an operation that has the same algebraic properties as addition, after transformation into their cepstrum, an operation called homomorphic transformation. The basic principle of homomorphic transformation is separating each frequency contribution using classical linear filtering after transforming the convolution into a sum, which can be obtained thanks to a homomorphic transformation and cepstrum estimation.

The cepstrum is defined by the following procedure. First, the modulus of the FT of s(t) is calculated and results in the following, which is defined by Equation 7:

$$\vert S ( F ) \vert = \vert {H}_{1} ( F ) \vert \times \vert {H}_{2} ( F ) \vert \times \vert E ( F ) \vert \qquad ( 7 )$$

where |H₁(F)|, |H₂(F)|, and |E(F)| are the modulus of the Fourier transform of h₁(t), h₂(t), and e(t), respectively.

This primary operation transforms the convolution into a product. To transform this product into a sum, the logarithm is then calculated and leads to Equation 8:

$$log ( \vert S ( F ) \vert ) = log ( \vert {H}_{1} ( F ) \vert ) + log ( \vert {H}_{2} ( F ) \vert ) + log ( \vert E ( F ) \vert ) \qquad ( 8 )$$

where log is the natural logarithm. However, it should be noted that any base can be used for the logarithm. In a last step the cepstrum of the output signal is obtained using an inverse Fourier Transform (IFT), which is defined by Equation 9:

$$𝒞 \{ s ( t ) \} = {ℱ}^{- 1} \{ log ( \vert S ( F ) \vert ) \} \qquad ( 9 )$$

$$Then ,$$

$$𝒞 \{ s ( t ) \} = 𝒞 \{ {h}_{1} ( t ) \} + 𝒞 \{ {h}_{2} ( t ) \} + 𝒞 \{ e ( t ) \} \qquad ( 10 )$$

$$with$$

$$𝒞 \{ {h}_{1} ( t ) \} = {ℱ}^{- 1} \{ log ( \vert {H}_{1} ( F ) \vert ) \} \qquad ( 11 )$$

$$𝒞 \{ {h}_{2} ( t ) \} = {ℱ}^{- 1} \{ log ( \vert {H}_{2} ( F ) \vert ) \} \qquad ( 12 )$$

$$and$$

$$𝒞 \{ e ( t ) \} = {ℱ}^{- 1} \{ log ( \vert E ( F ) \vert ) \} \qquad ( 13 )$$

As shown in FIGS. 5A-5C, FIGS. 6A-6C, and FIGS. 7A-7C, the logarithm of the FT modulus of the components of the acquired acoustic out signal, e.g., an A-scan signal, displays oscillating patterns. The signal processing approach of this disclosure includes splitting these individual contributions by linear filtering operations in the cepstral domain. These components, which represent the respective contribution of the coupling medium and/or wedge, echoes, and the material under test, are representative of front-wall and back-wall position, respectively.

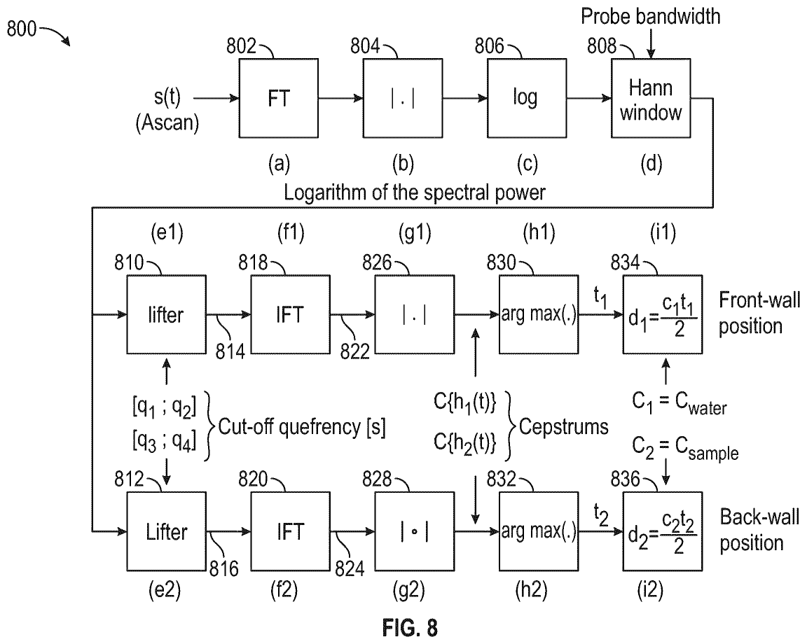

FIG. 8 is a flow diagram of an example of a method 800 for determining a thickness of a material using a probe assembly configured to emit ultrasonic waves and a non-destructive testing (NDT) technique. The method 800 is implemented using a processor, such as the processing circuit 102 of FIG. 1. Using the techniques of FIG. 8, a processor determines a cepstrum of the acoustic output signal, where the acoustic output signal includes successive echoes in a coupling medium or in a wedge, successive echoes in the material, and a probe response to the ultrasonic waves emitted by a probe assembly, such as the probe assembly 200 of FIG. 2.

At block 802, the method 800, such as implemented using the processing circuit 102 of FIG. 1, acquires an acoustic output signal s(t) of the material using the probe assembly, where the acoustic output signal includes multiple echoes resulting from an interaction of the emitted ultrasonic waves with the material. The processor receives the acoustic output signal s(t), such as part of an A-scan, and performs a Fourier transform (FT) of the signal, such as a fast Fourier transform (FFT). That is, a Fourier transform is performed on the acoustic output signal s(t) to transform the acoustic output signal from a time domain to a frequency domain.

At block 804, the method 800 determines a representation of an output of the Fourier transform. For example, the method 800 determines an absolute value of the Fourier transform of the signal, e.g., the modulus of the Fourier transform. The output of block 804 is proportional to the spectral power of the acoustic output signal.

At block 806, the method 800 applies a logarithmic function to a representation of an output of the Fourier transform, such as the absolute value of the Fourier transform of the signal, to generate a logarithm of a representation of the spectral power of the acoustic output signal.

At block 808, the method 800 applies an apodization technique to the logarithm of the representation of the spectral power, such as applying a window function to the logarithm of the spectral power. Example window functions include a Hanning (or Hann) window, a Hamming window, and the like. The method 800 may use the bandwidth of the probe assembly to apply the window function. The number of points is relative to the probe bandwidth.

The method 800 then filters a representation of the spectral power of the acoustic output signal to generate a first filtered signal and a second filtered signal. For example, at block 810 and block 812, the method 800 performs band-pass filtering process in the cepstral domain on a logarithm of the spectral power to generate a first filtered signal 814 and a second filtered signal 816. A filtering procedure in the cepstrum domain is referred to as liftering. The inputs q1, q2 to block 810 and the inputs q3, and q4 to block 812 represent the cut-off quefrencies, expressed in seconds. A quefrency is a measure of time, though not in the sense of a signal in the time domain.

At block 818 and block 820, the method 800 then performs an inverse Fourier Transform on each of the first filtered signal 814 and the second filtered signal 816 to generate a corresponding first time domain signal 822 and second time domain signal 824.

In some examples, the direct Fourier transform may be used in this step.

At block 826 and block 828, the method 800 determines an absolute value of each of the first time domain signal 822 and the second time domain signal 824. The outputs of the block 826 and the block 828 correspond, respectively, to the cepstrums [symbol] {h₁(t)} and [symbol] {h₂(t)}.

At block 830 and block 832, the method 800 determines, from cepstrums of each of the first and second time domain signals, corresponding time positions of a peak of maximum amplitude. For example, the method 800 determines, based on the cepstrum of the acoustic output signal, times of flight (TOF) t₁ and t₂ of the ultrasonic waves within the material. In other words, the method 800 estimates the time positions t₁ and t₂ corresponding to the maximum value of the peaks of the cepstrums [symbol] {h₁(t)} and [symbol] {h₂(t)}. In some examples, the method 800 determines an argument of the maximum (“arg max”) for each of the cepstrums [symbol] {h₁(t)} and [symbol] {h₂(t)}.

At block 834 and block 836, the method 800 performs a time-to-distance conversion to determine the thickness of the material based on the determined TOF and a known speed of sound in the material. For example, at block 834, the method 800 determines, using the time position of the peak of the maximum amplitude of the first time domain signal 822, a front-wall position of the material. The front-wall position or thickness is given by Equation 14:

$$d 1 = \frac{c 1 \times t 1}{2} \qquad ( 14 )$$

where c₁ is the sound wave velocity in the coupling medium, e.g., water, or the wedge and t₁ is the time period of the impulse response of the coupling medium and/or wedge.

Similarly, at block 836, the method 800 determines, using the time position of the peak of the maximum amplitude of the second time domain signal 824, a back-wall position of the material, where the thickness of the material is the back-wall position. The back-wall position or thickness is given by Equation 15:

$$d 2 = \frac{c 2 \times t 2}{2} \qquad ( 15 )$$

where c₂ is the sound wave velocity in the material under test and t₂ is the time period of the impulse response of the sample.

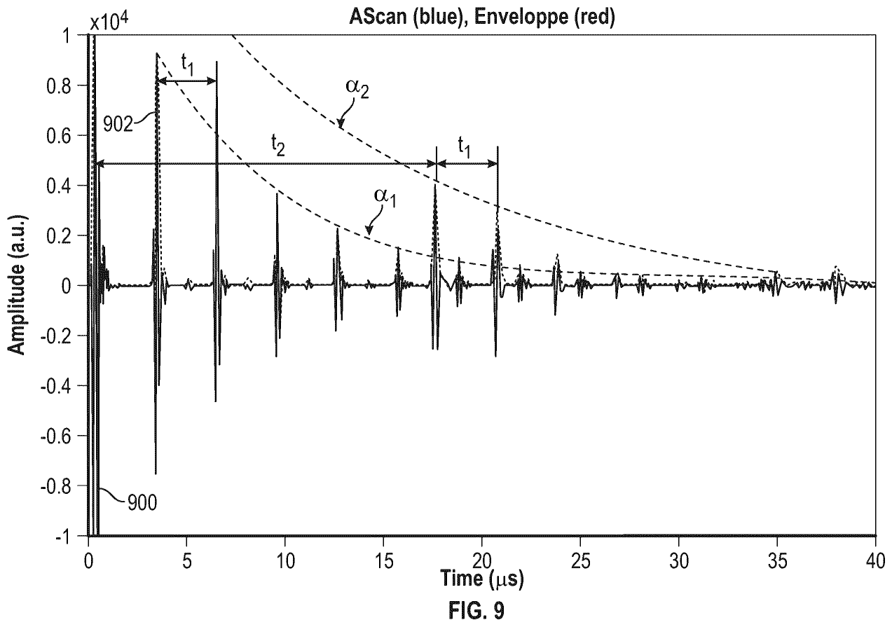

FIG. 9 graphically depicts a raw acoustic output signal and its envelope, showing the combination by convolution of all the components of the acoustic output signal. The x-axis represents time in microsecond and the y-axis represents amplitude in arbitrary units. The raw acoustic output signal 900, e.g., an A-scan, is depicted having decreasing amplitudes over time. An envelope 902 of the acoustic output signal 900 is also depicted, such as calculated using a Hilbert transform. Various signal parameters are depicted, including the time interval t₁ (back-wall) and t₂ (front-wall).

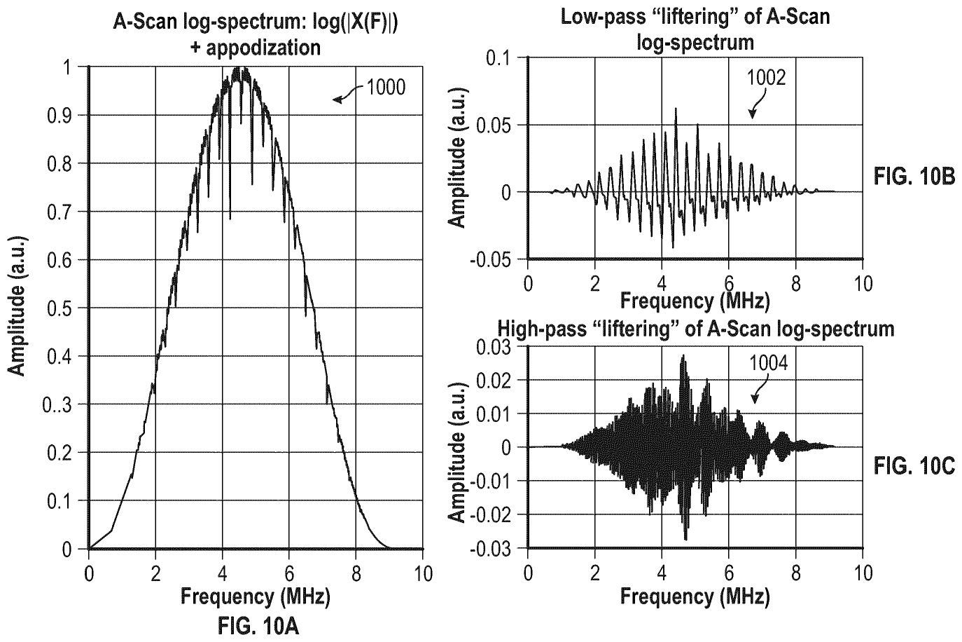

FIGS. 10A-10C graphically depict the logarithm of the spectral power (logarithm spectrum) of the acoustic output signal. FIG. 10A depicts a graph of a logarithm of the spectral power of the acoustic output signal 1000, or “log spectrum”, such as obtained by log(|X(F)|) plus apodization, where the x-axis represents frequency in megahertz and the y-axis represents amplitude in arbitrary units. In other words, FIG. 10A depicts a windowed log spectrum of an A-scan of the signal of s(t) of FIG. 8.

FIG. 10B depicts a low-pass liftering 1002 (filtering the cepstral domain) of the signal in FIG. 10A, where the x-axis represents frequency in megahertz and the y-axis represents amplitude in arbitrary units. The low-pass liftering 1002 includes back-wall information. FIG. 10C depicts a high-pass liftering 1004 (filtering the cepstral domain) of the signal in FIG. 10A, where the x-axis represents frequency in megahertz and the y-axis represents amplitude in arbitrary units. The high-pass liftering 1004 includes front-wall information.

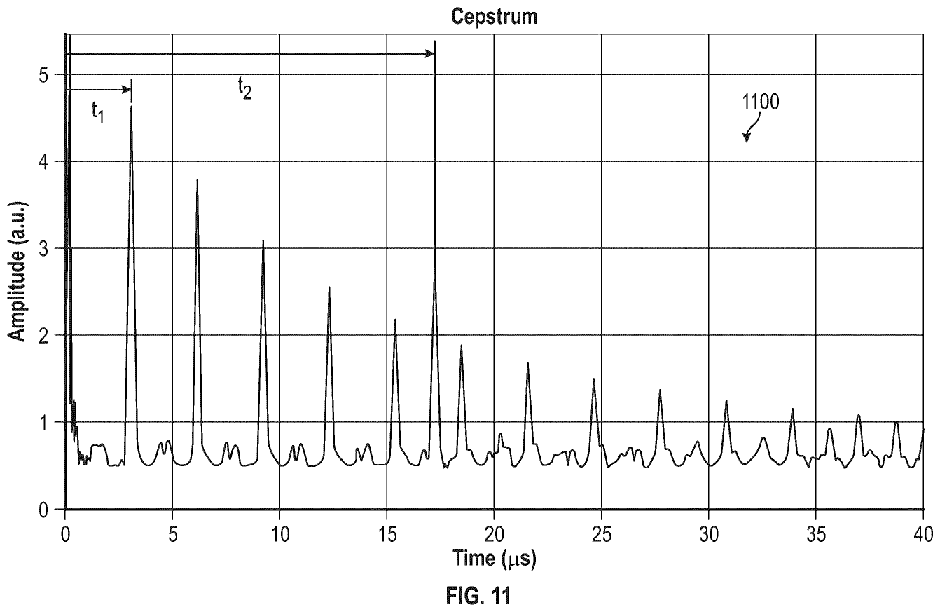

FIG. 11 graphically depicts a cepstrum 1100 of the acoustic output signal. The cepstrum 1100 of the acoustic output signal is the result of performing an inverse Fourier transform on the log-spectrum of the signal shown in FIG. 10A.

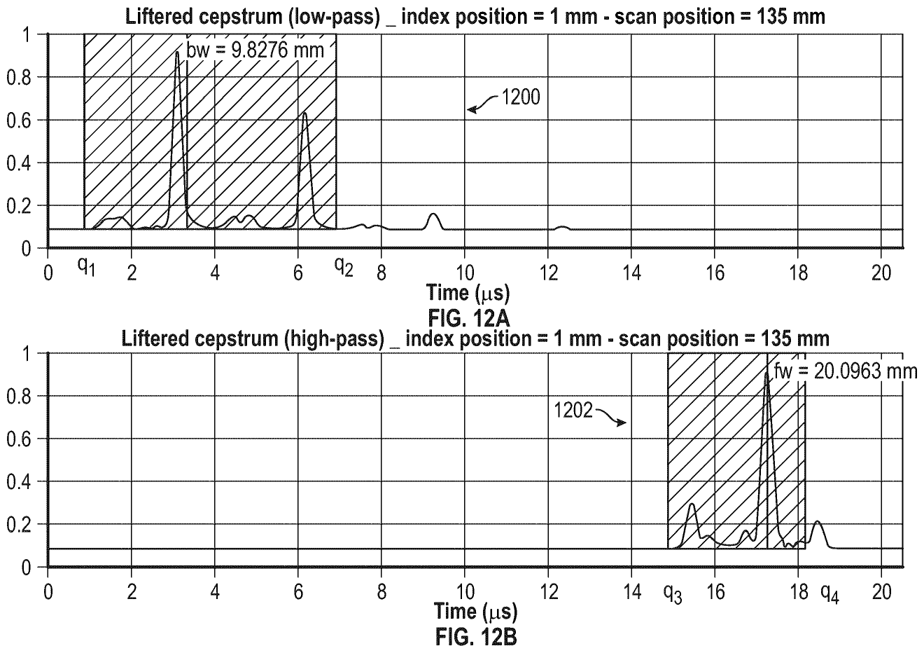

This figure shows that the two parameters t₁ and t₂ may be estimated in an absolute manner from a same time reference at 0 seconds. Moreover, the cepstrum computation makes it possible to hide the oscillatory component, caused by the probe response, as a Hilbert transform envelope detection procedure would have done, for example. To estimate t₁ and t₂, and consequently the back-wall and the front-wall position, a filtering procedure, called liftering in the cepstrum domain, is applied as explained before. This leads to the two liftered cepstrums shown in FIGS. 12A and 12B from which it is possible to separate the signatures of the two peaks, indicating the presence of both surfaces, namely the back-wall and front-wall of the material under test.

FIGS. 12A and 12B graphically depict liftered cepstrums. FIG. 12A depicts low-pass liftering 1200, or the low-pass component of the cepstrum 1100 of FIG. 11. The low-pass liftering 1200 is obtained by determining the inverse Fourier transform of the signal in FIG. 10B. The cut-off quefrencies are q1=1.31 μs, q2=6.55 μs.

FIG. 12B depicts 1202, or the high-pass component of the cepstrum 1100 of FIG. 11. The 1202 is obtained by determining the inverse Fourier transform of the signal in FIG. 10C. The cut-off quefrencies are q3=15.73 μs, q4=18.02 μs.

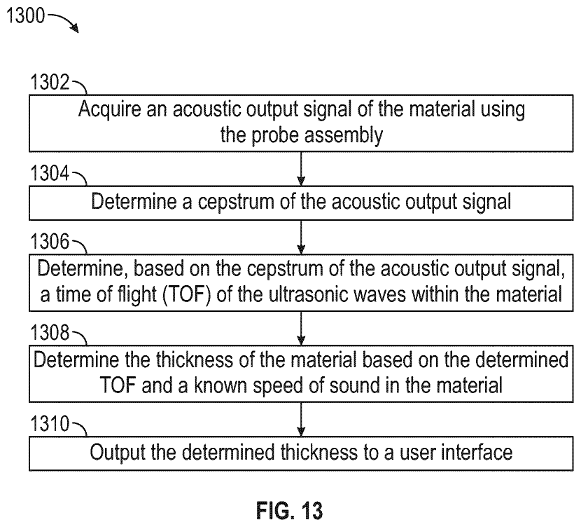

FIG. 13 is a flow diagram of another example of a method 1300 for determining a thickness of a material using a probe assembly configured to emit ultrasonic waves and a non-destructive testing (NDT) technique. The method 1300 is a simplified version of the method 800 shown in FIG. 8.

At block 1302, the method 1300 includes acquiring an acoustic output signal of the material using the probe assembly. At block 1304, the method 1300 includes determining a cepstrum of the acoustic output signal. At block 1306, the method 1300 includes determining, based on the cepstrum of the acoustic output signal, a time of flight (TOF) of the ultrasonic waves within the material. At block 1308, the method 1300 includes determining the thickness of the material based on the determined TOF and a known speed of sound in the material. At block 1310, the method 1300 includes outputting the determined thickness to a user interface, such as displaying a representation of the thickness on a display, e.g., the display 110 of FIG. 1.

The cepstrum techniques of this disclosure have demonstrated significant efficiency advantages over correlation-based methods. The effectiveness of the techniques is further enhanced by its unsupervised nature, making it less dependent on the user. This approach requires only a basic understanding of the nominal thickness range of the material being inspected and a general estimate of the height of the coupling medium, e.g., water column, and/or wedge.

The techniques of this disclosure stand out for their accuracy and repeatability, ensuring that measurements are consistent and comparable over time, which is particularly beneficial for tracking corrosion growth rates. Its design significantly reduces the dependency on the user, leading to more objective and reliable results.

Furthermore, the techniques are adept at managing instances of data loss, ensuring the integrity of the inspection process. The techniques also strategically avoid the use of less reliable techniques such as zero crossing and floating gates. By addressing these issues, the techniques enhance the robustness and reliability of the inspection process.

The techniques tackle common challenges in non-destructive testing by reducing the reliance on operator-dependent gates, which may introduce variability, and by ignoring the oscillating component of the probe's impulse response to prevent misinterpretation. The noise robustness of the techniques allows for operation at low excitation levels, minimizing the risk of signal saturation. The approach uses unbiased techniques with low estimation variance and considers “in line” calibration to compensate for temperature effects, ensuring accurate measurements.

By overcoming the need for time-reference knowledge and disregarding phase information, the techniques simplify the inspection process. The techniques align with the capabilities of NDT devices, such as the OmniScan X3® device, by favoring elementary, fast signal processing methods that are easy to implement and maintain. This advancement represents a significant step forward in the field of non-destructive testing, offering a more reliable and user-independent approach to material inspection.

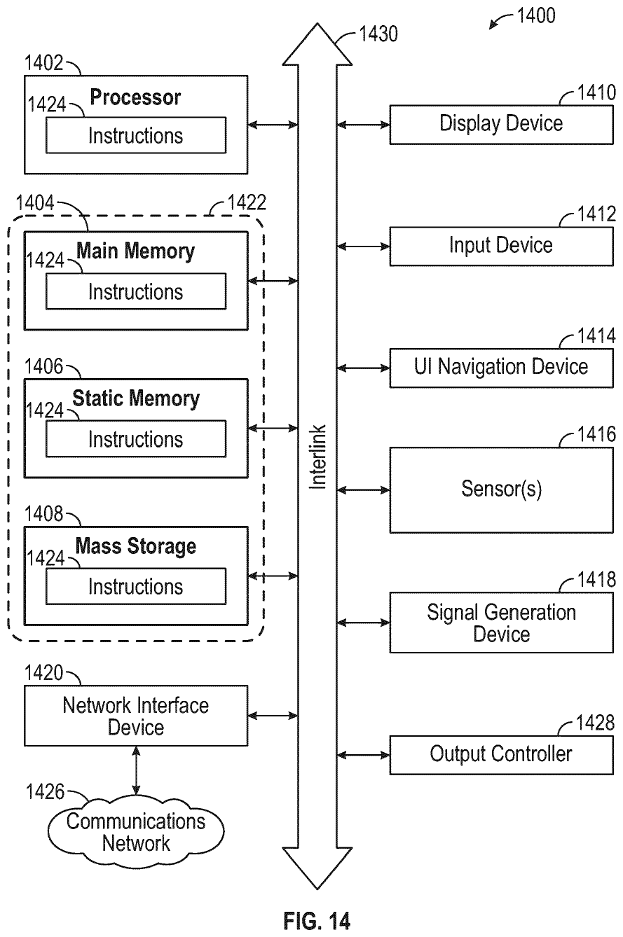

FIG. 14 illustrates a block diagram of an example machine 1400 upon which any one or more of the techniques (e.g., methodologies) discussed herein may perform. Examples, as described herein, may include, or may operate by, logic or a number of components, or mechanisms in the machine 1400.

Circuitry (e.g., processing circuitry) is a collection of circuits implemented in tangible entities of the machine 1400 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired).

In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa.

The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 1400 follow.

In alternative examples, the machine 1400 may operate as a standalone device or may be connected (e.g., networked) to other machines. In a networked deployment, the machine 1400 may operate in the capacity of a server machine, a client machine, or both in server-client network environments. In an example, the machine 1400 may act as a peer machine in peer-to-peer (P2P) (or other distributed) network environment. The machine 1400 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine 1400 may include a hardware processor 1402 (e.g., a central processing unit (CPU), a graphics processing unit (GPU), a hardware processor core, or any combination thereof), a main memory 1404, a static memory (e.g., memory or storage for firmware, microcode, a basic-input-output (BIOS), and mass storage 1408 (e.g., hard drives, tape drives, flash storage, or other block devices) some or all of which may communicate with each other via an interlink 1430 (e.g., bus). The machine 1400 may further include a display unit 1410, an alphanumeric input device 1412 (e.g., a keyboard), and a user interface (UI) navigation device 1414 (e.g., a mouse). In an example, the display unit 1410, input device 1412 and UI navigation device 1414 may be a touch screen display. The machine 1400 may additionally include a signal generation device 1418 (e.g., a speaker), a network interface device 1420, and one or more sensors 1416, such as a global positioning system (GPS) sensor, compass, accelerometer, or other sensor. The machine 1400 may include an output controller 1428, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 1402, the main memory 1404, the static memory 1406, or the mass storage 1408 may be, or include, a machine readable medium 1422 on which is stored one or more sets of data structures or instructions 1424 (e.g., software) embodying or utilized by any one or more of the techniques or functions described herein. The instructions 1424 may also reside, completely or at least partially, within any of registers of the processor 1402, the main memory 1404, the static memory 1406, or the mass storage 1408 during execution thereof by the machine 1400. In an example, one or any combination of the hardware processor 1402, the main memory 1404, the static memory 1406, or the mass storage 1408 may constitute the machine readable media 1422. While the machine readable medium 1422 is illustrated as a single medium, the term “machine readable medium” may include a single medium or multiple media (e.g., a centralized or distributed database, and/or associated caches and servers) configured to store the one or more instructions 1424.

The term “machine readable medium” may include any medium that is capable of storing, encoding, or carrying instructions for execution by the machine 1400 and that cause the machine 1400 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 1422 may be representative of the instructions 1424, such as instructions 1424 themselves or a format from which the instructions 1424 may be derived. This format from which the instructions 1424 may be derived may include source code, encoded instructions (e.g., in compressed or encrypted form), packaged instructions (e.g., split into multiple packages), or the like. The information representative of the instructions 1424 in the machine readable medium 1422 may be processed by processing circuitry into the instructions to implement any of the operations discussed herein. For example, deriving the instructions 1424 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 1424.

In an example, the derivation of the instructions 1424 may include assembly, compilation, or interpretation of the information (e.g., by the processing circuitry) to create the instructions 1424 from some intermediate or preprocessed format provided by the machine readable medium 1422. The information, when provided in multiple parts, may be combined, unpacked, and modified to create the instructions 1424. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 1424 may be further transmitted or received over a communications network 1426 using a transmission medium via the network interface device 1420 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 1402.11 family of standards known as Wi-Fi®, IEEE 1402.15.4 family of standards, peer-to-peer (P2P) networks, among others. In an example, the network interface device 1420 may include one or more physical jacks (e.g., Ethernet, coaxial, or phone jacks) or one or more antennas to connect to the communications network 1426. In an example, the network interface device 1420 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1400, and includes digital or analog communications signals or other intangible medium to facilitate communication of such software. A transmission medium is a machine-readable medium.

Various aspects of the disclosure are set forth as follows:

Aspect 1 can include or use subject matter (e.g., a system, apparatus, method, article, or the like) that can include or use an ultrasound inspection system configured for determining a thickness of a material using a non-destructive testing (NDT) technique, the system comprising: a probe assembly configured to emit ultrasonic waves; and a processor configured for: acquiring an acoustic output signal of the material using the probe assembly; determining a cepstrum of the acoustic output signal; determining, based on the cepstrum of the acoustic output signal, a time of flight (TOF) of the ultrasonic waves within the material; determining the thickness of the material based on the determined TOF and a known speed of sound in the material; and outputting the determined thickness to a user interface.

Aspect 2 can include or use or can optionally be combined with at least some features of Aspect 1 to include or use the ultrasound inspection system wherein the processor is further configured for: performing a Fourier transform on the acoustic output signal to transform the acoustic output signal from a time domain to a frequency domain.

Aspect 3 can include or use or can optionally be combined with at least some features of Aspects 1-2 to include or use the ultrasound inspection system wherein the processor configured for determining the cepstrum of the acoustic output signal is configured for: applying a logarithmic function to an output of the Fourier transform to generate a logarithm of a spectral power of the acoustic output signal.

Aspect 4 can include or use or can optionally be combined with at least some features of Aspects 1-3 to include or use the ultrasound inspection system wherein the logarithmic function is a natural logarithm.

Aspect 5 can include or use or can optionally be combined with at least some features of Aspects 1-4 to include or use the ultrasound inspection system wherein the processor is further configured for: applying a window function to the generated logarithm of the spectral power.

Aspect 6 can include or use or can optionally be combined with at least some features of Aspects 1-5 to include or use the ultrasound inspection system wherein the processor is further configured for: filtering a representation of the spectral power of the acoustic output signal to generate a first filtered signal and a second filtered signal.

Aspect 7 can include or use or can optionally be combined with at least some features of Aspects 1-6 to include or use the ultrasound inspection system wherein the processor is further configured for: performing an inverse Fourier Transform on each of the first filtered signal and the second filtered signal to generate corresponding first and second time domain signals.

Aspect 8 can include or use or can optionally be combined with at least some features of Aspects 1-7 to include or use the ultrasound inspection system wherein the processor is further configured for: determining, from cepstrums of each of the first and second time domain signals, corresponding time positions of a peak of maximum amplitude.

Aspect 9 can include or use or can optionally be combined with at least some features of Aspects 1-8 to include or use the ultrasound inspection system wherein the processor configured for determining the thickness of the material based on the determined TOF and a known speed of sound in the material is configured for: determining, using the time position of the peak of the maximum amplitude of the first time domain signal, a back-wall position of the material, wherein the thickness is the back-wall position.

Aspect 10 can include or use or can optionally be combined with at least some features of Aspects 1-9 to include or use the ultrasound inspection system wherein the processor is further configured for: determining, using the time position of the peak of the maximum amplitude of the second time domain signal, a front-wall position of the material.

Aspect 11 can include or use or can optionally be combined with at least some features of Aspects 1-10 to include or use the ultrasound inspection system wherein the acoustic output signal includes successive echoes in a coupling medium or in a wedge, successive echoes in the material, and a probe response to the emitted ultrasonic waves.

Aspect 12 can include or use subject matter (e.g., a system, apparatus, method, article, or the like) that can include or use a method for determining a thickness of a material using a probe assembly configured to emit ultrasonic waves and a non-destructive testing (NDT) technique, the method comprising: acquiring an acoustic output signal of the material using the probe assembly; determining a cepstrum of the acoustic output signal; determining, based on the cepstrum of the acoustic output signal, a time of flight (TOF) of the ultrasonic waves within the material; determining the thickness of the material based on the determined TOF and a known speed of sound in the material; and outputting the determined thickness to a user interface.

Aspect 13 can include or use or can optionally be combined with at least some features of Aspect 12 to include or use the method comprising: performing a Fourier transform on the acoustic output signal to transform the acoustic output signal from a time domain to a frequency domain.

Aspect 14 can include or use or can optionally be combined with at least some features of Aspects 12-13 to include or use the method wherein determining the cepstrum of the acoustic output signal includes: applying a logarithmic function to an output of the Fourier transform to generate a logarithm of a spectral power of the acoustic output signal.

Aspect 15 can include or use or can optionally be combined with at least some features of Aspects 12-14 to include or use the method comprising: applying a window function to the generated logarithm of the spectral power.

Aspect 16 can include or use or can optionally be combined with at least some features of Aspects 12-15 to include or use the method comprising: filtering a representation of the spectral power of the acoustic output signal to generate a first filtered signal and a second filtered signal.

Aspect 17 can include or use or can optionally be combined with at least some features of Aspects 12-16 to include or use the method comprising: performing an inverse Fourier Transform on each of the first filtered signal and the second filtered signal to generate corresponding first and second time domain signals.

Aspect 18 can include or use or can optionally be combined with at least some features of Aspects 12-17 to include or use the method comprising: determining, from cepstrums of each of the first and second time domain signals, corresponding time positions of a peak of maximum amplitude.

Aspect 19 can include or use or can optionally be combined with at least some features of Aspects 12-18 to include or use the method wherein determining the thickness of the material based on the determined TOF and the known speed of sound in the material includes: determining, using the time position of the peak of the maximum amplitude of the first time domain signal, a back-wall position of the material, wherein the thickness is the back-wall position.

Aspect 20 can include or use a machine-readable medium including instructions that, when executed by a machine, cause the machine to perform operations for: acquiring an acoustic output signal of the material using the probe assembly; determining a cepstrum of the acoustic output signal; determining, based on the cepstrum of the acoustic output signal, a time of flight (TOF) of the ultrasonic waves within the material; determining the thickness of the material based on the determined TOF and a known speed of sound in the material; and outputting the determined thickness to a user interface.

Aspect 21 can include or use or can optionally be combined with at least some features of Aspect 20 to include or use the machine-readable medium including instructions for: performing a Fourier transform on the acoustic output signal to transform the acoustic output signal from a time domain to a frequency domain.

Aspect 22 can include or use or can optionally be combined with at least some features of Aspects 20-21 to include or use the machine-readable medium wherein the instructions for determining the cepstrum of the acoustic output signal include instructions for: applying a logarithmic function to an output of the Fourier transform to generate a logarithm of a spectral power of the acoustic output signal.

### VARIOUS NOTES

Each of the non-limiting claims or examples described herein may stand on its own, or may be combined in various permutations or combinations with one or more of the other examples.

The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more claims thereof), either with respect to a particular example (or one or more claims thereof), or with respect to other examples (or one or more claims thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times.

Examples of these tangible computer-readable media may include, but are not limited to, hard disks, removable magnetic disks, removable optical disks (e.g., compact discs and digital video discs), magnetic cassettes, memory cards or sticks, random access memories (RAMs), read only memories (ROMs), and the like.

The above description is intended to be illustrative, and not restrictive. For example, the above-described examples (or one or more claims thereof) may be used in combination with each other. Other embodiments may be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

What is claimed is:

1. An ultrasound inspection system configured for determining a thickness of a material using a non-destructive testing (NDT) technique, the system comprising:
a probe assembly configured to emit ultrasonic waves; and
a processor configured for:
acquiring an acoustic output signal of the material using the probe assembly;
determining a cepstrum of the acoustic output signal;
determining, based on the cepstrum of the acoustic output signal, a time of flight (TOF) of the ultrasonic waves within the material;
determining the thickness of the material based on the determined TOF and a known speed of sound in the material; and
outputting the determined thickness to a user interface.

2. The ultrasound inspection system of claim 1, wherein the processor is further configured for:
performing a Fourier transform on the acoustic output signal to transform the acoustic output signal from a time domain to a frequency domain.

3. The ultrasound inspection system of claim 2, wherein the processor configured for determining the cepstrum of the acoustic output signal is configured for:
applying a logarithmic function to an output of the Fourier transform to generate a logarithm of a representation of a spectral power of the acoustic output signal.

4. The ultrasound inspection system of claim 3, wherein the logarithmic function is a natural logarithm.

5. The ultrasound inspection system of claim 3, wherein the processor is further configured for:
applying a window function to the generated logarithm of the representation of the spectral power.

6. The ultrasound inspection system of claim 1, wherein the processor is further configured for:
filtering a representation of a spectral power of the acoustic output signal to generate a first filtered signal and a second filtered signal.

7. The ultrasound inspection system of claim 6, wherein the processor is further configured for:
performing an inverse Fourier Transform on each of the first filtered signal and the second filtered signal to generate corresponding first and second time domain signals.

8. The ultrasound inspection system of claim 7, wherein the processor is further configured for:
determining, from cepstrums of each of the first and second time domain signals, corresponding time positions of a peak of maximum amplitude.

9. The ultrasound inspection system of claim 8, wherein the processor configured for determining the thickness of the material based on the determined TOF and a known speed of sound in the material is configured for:
determining, using the time position of the peak of the maximum amplitude of the first time domain signal, a back-wall position of the material,
wherein the thickness is the back-wall position.

10. The ultrasound inspection system of claim 9, wherein the processor is further configured for:
determining, using the time position of the peak of the maximum amplitude of the second time domain signal, a front-wall position of the material.

11. The ultrasound inspection system of claim 1, wherein the acoustic output signal includes successive echoes in a coupling medium or in a wedge, successive echoes in the material, and a probe response to the emitted ultrasonic waves.

12. A method for determining a thickness of a material using a probe assembly configured to emit ultrasonic waves and a non-destructive testing (NDT) technique, the method comprising:
acquiring an acoustic output signal of the material using the probe assembly;
determining a cepstrum of the acoustic output signal;
determining, based on the cepstrum of the acoustic output signal, a time of flight (TOF) of the ultrasonic waves within the material;
determining the thickness of the material based on the determined TOF and a known speed of sound in the material; and
outputting the determined thickness to a user interface.

13. The method of claim 12, comprising:
performing a Fourier transform on the acoustic output signal to transform the acoustic output signal from a time domain to a frequency domain.

14. The method of claim 13, wherein determining the cepstrum of the acoustic output signal includes:
applying a logarithmic function to an output of the Fourier transform to generate a logarithm of a representation of a spectral power of the acoustic output signal.

15. The method of claim 14, comprising:
applying a window function to the generated logarithm of the representation of the spectral power.

16. The method of claim 12, comprising:
filtering a representation of a spectral power of the acoustic output signal to generate a first filtered signal and a second filtered signal.

17. The method of claim 16, comprising:
performing an inverse Fourier Transform on each of the first filtered signal and the second filtered signal to generate corresponding first and second time domain signals.

18. The method of claim 17, comprising:
determining, from cepstrums of each of the first and second time domain signals, corresponding time positions of a peak of maximum amplitude.

19. The method of claim 18, wherein determining the thickness of the material based on the determined TOF and the known speed of sound in the material includes:
determining, using the time position of the peak of the maximum amplitude of the first time domain signal, a back-wall position of the material,
wherein the thickness is the back-wall position.

20. A machine-readable medium including instructions that, when executed by a machine, cause the machine to perform operations for:
acquiring an acoustic output signal of a material using a probe assembly;
determining a cepstrum of the acoustic output signal;
determining, based on the cepstrum of the acoustic output signal, a time of flight (TOF) of ultrasonic waves within the material;
determining a thickness of the material based on the determined TOF and a known speed of sound in the material; and
outputting the determined thickness to a user interface.

21. The machine-readable medium of claim 20, including instructions for:
performing a Fourier transform on the acoustic output signal to transform the acoustic output signal from a time domain to a frequency domain.

22. The machine-readable medium of claim 21, wherein the instructions for determining the cepstrum of the acoustic output signal include instructions for:
applying a logarithmic function to an output of the Fourier transform to generate a logarithm of a representation of a spectral power of the acoustic output signal.
